(19) United States
(12) Patent Application Publication
(10) Pub. No.: US 2026/0306980 A1
(43) Pub. Date: Oct. 8, 2026

(54) FILTER SYSTEM FOR THE REMOVAL OF VOLATILE ORGANOSULFUR COMPOUNDS (VOSCS) FROM INDOOR AIR

(71) Applicant: AIR TECH GROUP, SLU, Sarral Tarragona (ES)

(72) Inventors: Jaume VILARRASA LLORENS, Barcelona (ES); Fernanda ARRIBAS CROVARA, Sant Celoni (ES); Lluís BOSCH HEREU, Santa Maria de Palautordera (ES)

(21) Appl. No.: 19/484,573

(22) PCT Filed: Jun. 3, 2025
(86) PCT No.: PCT/EP2025/065255

§ 371 Date: Nov. 14, 2025

(30) Foreign Application Priority Data
Jun. 5, 2024 (EP) 24382605.4

(51) Int. Cl. B01D 39/20; B01D 27/02

(52) U.S. Cl. CPC B01D 39/2072; B01D 27/02; B01D 2251/106; B01D 2251/604; B01D 2252/10; B01D 2257/306; B01D 2257/708; B01D 2259/4508

(57) ABSTRACT

The present disclosure relates a filter system for an air decontamination device for the removal of volatile organosulfur compounds (VOSCs) from indoor air at room temperature, comprising a filter cartridge, the filter cartridge containing granules and/or pellets made of two zinc compounds, the two zinc compounds being zinc hydroxide, Zn(OH)₂, and zinc peroxide, ZnO₂, and wherein the filter acts as an absorption filter, reacting irreversibly with the volatile organosulfur compounds that may contaminate the indoor air, either vapors of liquid organic thiols (RSH), of liquid dialkyl oligosulfides (RS—SR and RS—S—SR, including those present in Allium species), and of the solvent carbon disulfide (CS₂). The disclosure also relates to a method for removing these groups of volatile organosulfur compounds from indoor air, wherein a controlled airflow of the indoor air is passed through a filter system comprising granules or pellets prepared from zinc hydroxide, Zn(OH)₂, and zinc peroxide, ZnO₂, and wherein the volatile organosulfur compounds irreversibly react with the hydroxide and peroxide ions of the aggregates (either pellets or granules) to yield solid and innocuous zinc salts, and are thereby captured in the filter system.

### TECHNICAL FIELD

The present disclosure relates to a filter system for the removal of vapors of some groups of organosulfur compounds, specifically of vapors of liquid thiols (R—SH), of organic oligosulfides (such as R—S—S—R and R—S—S—S—R, also called dialkyl polysulfides), and of the solvent carbon disulfide (CS₂, S═C═S), from indoor air and to a method for removing such compounds from indoor air.

### BACKGROUND ART

Volatile sulfur compounds (VSC) are established hazardous and toxic and/or stinking compounds. They comprise a plethora of sulfur-containing organic molecules, that is, of dozens of volatile liquids, which together may be named volatile sulfur organic compounds or volatile organosulfur compounds, VOSC, or VOSCs, to differentiate them from all other volatile organic compounds (the so-called VOCs, which comprise thousands of gases and liquids belonging to all classes of organic molecules).

There are some sulfur compounds, either inorganic or organic, that are gases at room temperature and atmospheric pressure, like hydrogen sulfide (H₂S), methanethiol (CH₃SH), carbonyl sulfide (COS), and sulfur dioxide (SO₂). These gases are not treated in the present application, since the removal in connection with the petroleum industry is well established.

The present application is limited to the removal from indoor air of vapors of some groups of organosulfur compounds (VOSCs) for which no specific treatments have been published, namely:
A) Dozens of liquid organic thiols (RSH), especially those more volatile, have a very unpleasant odor. The low molecular weight liquids ethanethiol (ethyl mercaptan, CH₃CH₂SH, “stench gas”, rotten cabbage) and allyl mercaptan (present in garlic and many other plants of the genus Allium) are toxic at high concentrations. Ethanethiol, for example, depresses the central nervous system and affects the respiratory center, producing death by respiratory paralysis. Thiophenol (PhSH, LC₅₀=33 ppm in rats) and 1-dodecanethiol are toxic at high concentrations as well. Even the less volatile alkanethiols, such as 1-octadecanethiol, ‘may be harmful by ingestion, inhalation or through skin contact; they are eye, skin, and respiratory irritants’, according to US National Institute of Health, NIH.

Many liquid organic sulfides (R—S—R′, also called thioethers) have foul smell and show toxicity by inhalation. However, they are not treated in this application, as the oxidation of some members of this group, such as the mustard gas (ClCH₂CH₂—S—CH₂CH₂Cl) and diethyl sulfide (CH₃CH₂—S—CH₂CH₃), have been the subject of many studies since its use as toxic gases in the First World War, and because their oxidation do not produce solid zinc salts but sulfoxides (R—SO—R) and sulfones (R—SO₂—R).
B) Organic disulfides/trisulfides/tetrasulfides (that is, organic oligosulfides, often generally called dialkyl polysulfides) also have foul smell, either strong garlic-like odor or feces stench. Diallyl disulfide (CH₂═CHCH₂—S—S—CH₂CH=CH₂) is a typical component of garlic, with a few medicinal properties (but it may cause allergic contact dermatitis and has LD₅₀=260 mg/kg in rats), whereas dipropyl disulfide (CH₃CH₂CH₂—S—S—CH₂CH₂CH₃) is abundant in onions; allyl propyl disulfide and said dipropyl disulfide (onions) are poisonous to dogs and cats. Mixtures of dialkyl disulfides and trisulfides are called disulfide oil (DSO) in the petroleum industry. Despite the moderate toxicity of R—S—R′, R—S—S—R′, R—S—S—S—R′ (LD₅₀ for rats=50 g/m³/8 h for the dimethyl derivative, by inhalation), etc., even slight concentrations in indoor air of industrial kitchens, hotels, hospital canteens, public toilets, etc., are obviously contraindicated. Houses and buildings close to food industries processing onions, garlics, scallions, ramps, etc. should also be isolated of the corresponding smells.

Allium sativa (garlic) contains a long list of VOSCs. Besides the above-mentioned disulfides (mainly diallyl disulfide), other cyclic sulfides and disulfides have been characterized, including thiophene derivatives, the smell of which are uncomfortable at an industrial level. On the other hand, when a garlic clove is chopped, a special disulfide oxide, allicin (S-allyl 2-propenethiosulfinate, CH₂═CHCH₂—S(═O)—S—CH₂CH═CH₂), is enzymatically generated, as well as more complex sulfoxides such as ajoene isomers (which are beneficial and non-volatile, and consequently not dealt with here).

Allium cepa (onion) also contains a long list of volatile dialkyl disulfides and trisulfides, fortunately of scarce or moderate toxicity for humans. Pungency is mainly attributed to these disulfides, many of which are different from those of garlic. Moreover, when the cells are chopped another enzymatic reaction is triggered that releases a well-known lachrymatory agent (the Z isomer of propanethial S-oxide, CH₃CH₂CH═S═O). It is hydrolyzed in our mucosa to yield propanal and a low-valent sulfur intermediate and perhaps some propanesulfinic acid as well. These compounds cause tearing as a defensive response of the eyes. Fortunately, this volatile by-product is soluble in water and decomposes with water, as it is well-known, but food processing industries would not rather cut hundreds of onions under a water stream. To remove this special sulfoxide from the manufacturing plant and surrounding buildings, an appropriate filter would be useful.
C) Carbon disulfide (CS₂, S═C═S) is a neurotoxic solvent and reagent of sweetish odor like chloroform, used in the manufacture of perfumes, cellophane, rayon, and some types of rubber, as well as a soil fumigant. As a solvent, it was forbidden in laboratories decades ago, owing to its hepatotoxicity and flammability. All governmental agencies indicate threshold limit values of 1 ppm over an 8-h shift. Increased mortality has been described at 6 ppm. LD₅₀ values of 3.2 g/kg (rat) have been reported. Trithiocarbonic acid or thiocarbonic acid (H₂CS₃, HS—CS—SH) is also a liquid of low boiling point, whose decomposition gives carbon disulfide (and H₂S). Xanthates or dithiocarbonic acid derivatives of general formula ROC(═S)S⁻M⁺, ROC(═S)SH, and ROC(═S)SR′, often used as pesticides or in mining processes, as well as dithiocarbamates or dithiocarbamic acid derivatives, R₂NC(═S)S⁻M⁺, R₂NC(═S)SH, R₂NC(═S)SR′, etc., used in the vulcanization of rubber, whose thermal decomposition and/or hydrolysis readily deliver CS₂, may be included in this group even though many of them are solids or liquids of low vapor pressure (but still poisonous).

There are no specific patents on the removal from indoor air, at room temperature, of vapors of liquid VOSCs of group A (liquid thiols), of group B (organic disulfides, organic trisulfides, etc.) and of group C (vapors of the solvent carbon disulfide, CS₂, of trithiocarbonic acid and of the above-mentioned precursors). Furthermore, there are no specific patents for the simultaneous elimination of these three groups of VOSCs.

In other words, there are several reagents that can capture or remove gases such as H₂S/CH₃SH, COS and SO₂, in the petroleum and coal industries, from the wastewater, or from the chemical and pharmaceutical processes that yield these by-products or their precursors in large amounts. The most popular is zinc oxide (ZnO). The reaction of ZnO with H₂S to give ZnS is known from the beginnings of chemistry. Moreover, many oxidizing reagents can convert H₂S into sulfur (Sa) and/or into high oxidation states of sulfur, even into sulfate ion, as well as SO₂/sulfites into SO₃/sulfates. Thus, many patents covered and a few still cover these possibilities and related reactions, mainly for the removal of these gases in industrial settings, as above-mentioned, namely:

US2016/0250370 discloses a deodorizer made of hydrophobic zeolite+ZnO (‘adsorbent’, sic, for H₂S and CH₃SH)+MnO₂ (catalyst, also suitable for ‘removing sulfide’, sic).

WO2015/069357 describes a gas mask with two filters of impregnated carbon, the first with one metal/TEDA (triethylenediamine) and the second with Zr(OH)₄ and ‘zinc(hydr)oxide’, to trap several toxic inorganic gases, but only NOx, NH₃, and SO₂ were evaluated. As known, ‘zirconium hydroxide is a reactive substrate for the removal of sulfur dioxide’. Also, ‘inclusion of zinc (hydr)oxide in the second filter media particles may help filter HCN, (CN)₂, and NH₃ from air streams.’

US2015/0306536 indicates the capture of SO₂, H₂S, HCHO, NH₃, HCN, ClCN, COCl₂, cyclohexane (sic), NO₂ and PH₃, where, besides a first filter based on activated carbon (see above), there is a second filter that contains Zr(OH)₄ (zirconium hydroxide) and zinc oxide or zinc hydroxide plus one or more cobalt compounds. Organosulfur compounds were not studied. No claims regarding VOSCs are included.

US2018/0291284 is titled ‘Microparticles for scavenging H₂S and/or mercaptans’. Microparticles, from an aqueous suspension of silica or alumina, are impregnated with Fe²⁺ or Zn²⁺ salts. All the commercially available salts or compounds containing Zn²⁺ (up to 21, including zinc hydroxide and zinc peroxide) are mentioned in the summary. They are treated with a basic aqueous solution, so the active species is always (perhaps with one exception) zinc hydroxide, but it is not mentioned either. The terms ‘sulfide scavenging nanoparticle’ (but no ‘microparticle’ as in the title) and ‘sulfide-reacting metal’ are incorrectly used several times, as the authors only deal with the capture of hydrogen sulfide (H₂S): no real organic sulfides (dialkyl sulfides) are treated; no thiols are included in any example and in any claim. The aqueous suspension is used in petroleum extraction processes, wastewater processes, and similar activities (not as a decontamination device for indoor air).

US1989/4888157 has a very general title, ‘Sulphur compounds removal’, but only carbonyl sulphide (COS), hydrogen sulfide (H₂S), and mercaptans (in this case, without any example, any formula, or any comment) are claimed to be removed by agglomerates of CuO/ZnO/Al₂O₃, which are ignited at 900 °C, where ‘the content of CuO and ZnO present in said ignited agglomerates is at least 70% by weight’. Claim 9 indicates that ‘said agglomerates contain at least one compound selected from the group consisting of ZnO, Zn(OH)₂, ZnCO₃, and zinc basic carbonate’, but after heating—even at much lower temperatures than 900 °C—the three latter compounds decompose to ZnO. In other words, the agglomerates can only contain ZnO.

CN 2003/1415402 deals with the use of ZnO—TiO₂-Al₂O₃ to capture H₂S. In page 6 (of the English translation), ZnO·2CO₂·4H₂O is reported, apparently referring to a hydrated form of zinc hydrogen carbonate, that is, Zn(HCO₃)₂·3H₂O.

CN 2014/103769038 (also 041 and 044) reports a Desulfurizing adsorbent (sic) for gas and preparation and application of the same, where the absorbent is a mixture of ZnO, SiO₂, ‘Mo carbide and calcium oxysalt’, which is suitable for the removal of H₂S, sulfur oxides, and ‘thioether’ (sic, though it may be a translation problem) in natural gas, oil field gas, flu gas, and exhaust gas.

US2010/0180770 is addressed to ‘adsorb hydrogen sulfide gas (also known as H₂S) and other gasses including but not limited CO₂’ (sic). Activated carbon plus a granular combination of MgO, TiO₂ and ZnO is the absorbent material.

US2022/0161180 discloses an industrial air cleaner. Claim 11 indicates that the device comprises a metal oxide, claim 17 deals with a water spray generating a waste-water stream, while claim 20 points out that the pollutants comprise particulate matter, CO, H₂S, and nitrogen oxides.

US2012/8333824 reports a ‘Sorption agent comprising an AC impregnated with a Zn compound and a molybdenum compound and gas-filtering element containing the sorption agent’ to bind HCN and SO₂, mainly. What is claimed is the efficiency of: (1) activated carbon (AC) impregnated with 0.5-15 wt % of at least one Zn compound in the form of ZnCO₃ and zinc halide plus 0.5-15 wt % of molybdate; (3) the zinc compound also in the form of a hydroxide and/or oxo or polyoxoanions of molybdate; (7) dissolving zinc carbonate, NH₄Cl, (NH₄)₂CO₃, and sodium molybdate; (10) Zn as oxide, carbonate, halide, hydroxide, sulfate, and/or oxo or polyoxo anions of molybdate for simultaneously filtering HCN, SO₂, and H₂S from an environment.

WO2021/091076 discloses a catalyst for pretreatment of desulfurization comprising (a) at least one oxide; (b) at least one metal; and (c) at least one liquid composition selected. This catalyst is supplied to a ship fuel oil and is intended to adsorb sulfur oxides present therein.

US1993/5248489 indicates a method to remove H₂S from a fluid stream by contacting the fluid stream, under suitable conditions, with an absorbing composition consisting essentially of ZnO and silica (SiO₂).

EP1990/0401789 discloses a method to remove hydrogen sulfide from a fluid stream by contacting the fluid stream under suitable conditions with an absorbing composition consisting essentially of ZnO and silica and, preferably, a metal oxide promoter (NiO).

US2008/0271602 reports on sorbent compositions that include a SiO₂ porous support, impregnated with a mixture comprising ZnO and copper material, which may be utilized in systems and methods for removing sulfur compounds from gaseous streams (not specified, presumably H₂S). Moreover, this patent application also discloses a filter material comprising the sorbent composition and a process for removing sulfur compounds from a stream, passing the stream at 100-900 °C through the sorbent composition. An oxidizing agent (such as ozone, O₃, or hydrogen peroxide, H₂O₂) may be used to remove the sulfur compounds ‘adsorbed’ to the sorbent.

WO2009/064453 describes methods and apparatuses for reducing or eliminating stench. Specifically, a method is provided for the reduction of malodors from indoor air using vapor phase hydrogen peroxide (H₂O₂) generated from either evaporation from a pH neutral to mildly acidic aqueous-based liquid composition or sublimation from a solid composition containing at least one pH neutral to mildly acidic solid hydrogen peroxide-containing compound. The vapor phase hydrogen peroxide (VPHP) engages a media coated with at least one transition metal element or compound in the presence of air that contains malodorous compounds. The combination of the vapor phase hydrogen peroxide and the transition metal compound, which acts as an oxidation catalyst, provides increased efficacy of malodor molecule oxidation.

Zinc hydroxide, Zn(OH)₂, is commercially available. It is a moderate base, with well-known amphoteric properties. The use and advantages of this compound for the removal of organosulfur compounds is hardly disclosed in the prior art.

One patent (ICI, ZA1989/8804251, titled Removal of sulfur compounds from gas streams) describes an intimate mixture of oxides, hydroxides, carbonates, and/or basic carbonates of Cu, Zn, and other elements for the removal of H₂S and COS at 100 °C. However, these mixtures were previously calcined, so that the agglomerate is a mixture of oxides (CuO/ZnO/Al₂O₃), that is, one of the active components is ZnO rather than Zn(OH)₂.

There is another patent (US2002/0102229, Product for and method of controlling odor) that reports mixtures of H₂O₂, oxides/hydroxides/peroxides/carbonates/etc. of Zn/Fe/Ca/Mg/etc. and metallic nitrates ‘for substantially eliminating foul odors of H₂S’, but organosulfur compounds in general (or VOSCs of types A/B/C in particular) were not investigated.

With respect to the removal or capture of CS₂, there is one paper and one patent that have some relationship with the present subject. The article, titled Carbon disulfide removal from gasoline fraction using zinc-carbon composite synthesized using MW-assisted homogeneous precipitation (Environm. Sci. Pollution Res. 2023, 30, 82014-82030), deals with the loading on the carbon surface of the product of heating zinc nitrate with urea to yield ZnO, Zn(OH)₂ and 2ZnCO₃·3Zn(OH)₂ (that is, basic zinc carbonate). The results indicated that ‘ZC (Zn-Carbonate)’ had the highest CS₂ ‘adsorption’ capacity.

The patent, WO2018/1841158 (CN2017/079507W), Preparation method of composite material having nitrogen-doped graphene/zinc hydroxide/hollow-sulfur particles, involves many complex steps (addition of S to CS₂, addition of Ni powder, treatment with FeCl₃, adding the precipitate into a solution containing ZnCl₂, urea, and a surfactant, etc.), ‘aimed at improving electrochemical properties’, but apparently not at removing VOSCs.

Zinc peroxide, ZnO₂, is commercially available and had enjoyed some medical and pyro-technical applications. However, there are no patents describing its use to capture or remove organosulfur compounds, even though this reagent is much less dangerous than most metallic peroxides. No document in the prior art deals with the removal or capture of thiols (A), organic disulfides/trisulfides (B) and/or carbon disulfide and precursors (C):

There is a patent (CN2018/108970353, titled Comprehensive desulfurization and ‘denitration’ method of catalytic flue gas and ammonia gas-containing acidic gas), which explains how to remove H₂S from catalytic flue gas with Fe₂O₃ or with ZnO, as clearly indicated in the claims; ZnO₂ is only written in the summary, which apparently is a machine translation mistake. Anyway, there is no conflict between this patent and the present patent application, which does not deal with the removal of gaseous and inorganic sulfur compounds like H₂S.

There is only one article (Appl. Catal. B: Environ. 2018, 226, 429-440) that reports on the reaction of ZnO₂ with diethyl sulfide (oxidation) and 2-chloroethyl ethyl sulfide (replacement of Cl by OH), in the light of X-ray, SEM, Raman spectroscopy, and other techniques. These or any other dialkyl sulfides, also called thioethers, of general formula R—S—R′, are not treated in the present patent application, as already indicated. The oxidation of dialkyl sulfides with peroxides or peroxosalts is known, from the beginnings of organic chemistry, to give sulfoxides and sulfones, which are stable high-boiling liquids in general. By contrast, the goal of the present application is to capture VOSCs that in contact with Zn(OH)₂—ZnO₂ will mainly afford white salts such as zinc thiolates and/or eventually zinc sulfonates or zinc sulfate.

Mixtures or combinations of these two compounds, Zn(OH)₂ and ZnO₂, have never been reported as reagents for organic synthesis, to the best of the applicant knowledge. Aggregates or nanoparticles of zinc cations with hydroxide anions and peroxide anions as ligands have never been reported either. Obviously, this combination has never been used as a reagent for the removal of VOSCs, and specifically for the removal of contaminants of groups A, B, and C as disclosed in the present application.

To summarize, the prior art is silent to a filter suitable for the removal from indoor air (that is, at ambient or room temperature, not from crude oil at high temperature) of vapors of liquid thiols (section or group A), of liquid organic disulfides/trisulfides/etc. (organic oligosulfides, or dialkyl polysulfides in general, belonging to group or type B) and of solvent CS₂ (and precursors, type C). Any simple filter that can completely and irreversibly trap or capture at room temperature contaminants of these groups of VOSCs from indoor air, as well as samples of the three types simultaneously, by converting all of them into innocuous, non-volatile, white Zn salts, would be very useful from a social point of view. This is the goal of the present application.

### SUMMARY OF THE DISCLOSURE

In order to address one or more of the foregoing problems, one aspect of the present disclosure provides a filter system for an air decontamination device for the removal of volatile organosulfur compounds (VOSCs) from indoor air at room temperature, comprising a filter cartridge, the filter cartridge comprising granules and/or pellets made from two zinc compounds, the two zinc compounds being zinc hydroxide, Zn(OH)₂, and zinc peroxide, ZnO₂, and wherein the filter acts as an absorption filter, reacting irreversibly with the volatile organosulfur compounds that may contaminate the indoor air.

The two zinc compounds are commercially available crystalline solids and fully compatible.

The combination of these two Zn reagents has been not previously reported in the chemical literature or in previous patents. When combined in the form of pellets or granules, apart from the practical advantages of working with pellets or granules instead of using powders, they show a synergic effect, as the inventors have experimentally noted.

There are few non-hazardous and non-toxic basic reagents that can be safely included in a filter, designed to operate at ambient temperature in a room, toilet, apartment, hotel, hospital, airplane, cinema, school or lecture room, to name a few uses.

The two zinc compounds are preferably mixed in water or alcohol (preferably ethanol), forming a suspension, and then converted into white pellets or granules. The suspension (a slurry or gel) is extruded and allowed to dry, i.e. at the air or in glass desiccators, obtaining a dried material. This dried material, which is porous, is then easily cut into portions. The resulting granules and/or pellets look like pellets of activated carbon but of white color. The granules might have a diameter of 3±1 mm (about 3 mm) and the pellets may have a diameter of up to 5 mm of diameter and a length of 5±1 mm (about 5 mm).

Addition of commercially available agglomerating agents or chemical binders, such as povidone, microcrystalline cellulose, or calcium phosphate, is not required. In fact, pellets prepared from water suspensions or from alcoholic suspensions are more resistant to pressure—are less fragile, are not easily converted into powder—than the pellets prepared either using these chemical binders, from suspensions in organic solvents, or from suspensions in hydrogen peroxide solutions.

The filter system according to the present disclosure comprises zinc hydroxide and zinc peroxide in a weight ratio between 1:9 to 9:1, depending on the main contaminants that are expected in a house, hospital, school, airplane, or auditorium. As shown below, 1:2 ratio w/w is preferred for general cases, as explained in the Experimental Section.

The filter cartridge in the filter system as disclosed herein may also be placed between two filters of nonwoven fabric. The filter system may also comprise a final EPA or HEPA filter.

Another aspect of the present disclosure relates to a method for removing volatile organosulfur compounds from indoor air, wherein a controlled airflow of the indoor air is passed through a filter system comprising granules or pellets of a mixture/combination of zinc hydroxide, Zn(OH)₂, and zinc peroxide, ZnO₂, and wherein the volatile organosulfur compounds irreversibly react with the zinc hydroxide-peroxide aggregate. In other words, the volatile organosulfur compounds react with the hydroxide and/or peroxide anions of the aggregates, and are captured in the filter system as innocuous, white, non-volatile zinc salts.

The volatile organosulfur compounds (VOSCs) removed in the disclosed method are preferably vapors of liquid organosulfur compounds belonging to types/groups A-C:

In particular, and not limited to, the liquid organic thiols (type or group A) may be aliphatic thiols such as ethanethiol and 1-butanethiol, as well as aromatic thiols such as thiophenol.

In particular, and not limited to, the organic oligosulfides (group B) may be aliphatic disulfides (R—S—S—R), such as dimethyl disulfide (CH₃—S—S—CH₃) and dimethyl trisulfide (CH₃—S—S—S—CH₃). Featured derivatives present in Allium species, such as diallyl disulfide and dipropyl disulfide (plus the lachrymatory factor of onions that comes from the second), besides oxidation derivatives, such as thiosulfinates (R—SO—S—R), have also been examined.

In particular, the solvent carbon disulfide (S═C═S) has been studied in full detail, as the key representative of type or group C, which included above-mentioned precursors such as trithiocarbonic acid (HS—CS—SH) and its derivatives, as well as volatile xanthates.

Mixtures of components of these three groups have also been investigated.

In the method herein disclosed, the controlled airflow of the indoor air is preferably passed through the filter system at room temperature.

### BRIEF DESCRIPTION OF THE FIGURES

The features and advantages of the filter system according to the present disclosure can be better understood with the help of the attached Figures, which should be taken in an illustrative and non-limitative manner.

FIG. 1 shows the evolution of the concentrations of the indicated thiols as a function of time, on passing a continuous stream of contaminated air through independent glass columns filled with 12.0 g of the potential absorbents: pellets of Zn(OH)₂—ZnO₂ (1:2 w/w); Zn(OH)₂ powder; ZnO₂ powder; and ZnO powder. Mixtures of 1:2 and 1:1 w/w of Zn(OH)₂ and ZnO₂ powders, non-pelletized, gave rise to graphics (not included in FIG. 1 for the sake of simplification) with intermediate values between those of Zn(OH)₂ and ZnO₂, as expected.

FIG. 2 shows the changes of concentration of the indicated organic disulfides and of dimethyl trisulfide on passing a continuous stream of contaminated air through independent glass columns filled with 12.0 g of the potential absorbents: pellets of Zn(OH)₂ —ZnO₂ (1:2 w/w); Zn(OH)₂ powder; ZnO₂ powder; and ZnO powder. Mixtures of 1:2 and 1:1 w/w of Zn(OH)₂ and ZnO₂ powders, non-pelletized, gave rise to graphics (not included in FIG. 2) with intermediate values between those of Zn(OH)₂ and ZnO₂, obviously.

FIG. 3 shows the changes of concentration of commercial allicin (CH₂═CHCH₂—SO—S—CH₂CH═CH₂), of vapors of onions, and of vapors of garlics on passing a continuous stream of air through these materials and then through independent glass columns filled with 12.0 g of the potential absorbents: pellets of Zn(OH)₂—ZnO₂ (1:2 w/w); Zn(OH)₂ powder; ZnO₂ powder; and ZnO powder. Air streams with higher concentrations of volatiles (TVOC) than 4.12 ppm (from minced onion) and 2.33 ppm (from chopped garlic) were hard to generate.

FIG. 4 shows the concentration of the vapors of carbon disulfide (CS₂) on passing a continuous stream of air contaminated with this solvent through independent glass columns filled, as in previous Figures, with 12.0 g of the potential absorbents: pellets of Zn(OH)₂—ZnO₂ (1:2 w/w); Zn(OH)₂ powder; ZnO₂ powder; and ZnO powder. It appears that CS₂ is more sensitive to oxidation by a peroxide like ZnO₂ than to the moderate basic character of Zn(OH)₂. Considering the lower content of ZnO₂ in the pellets (33% w/w, first column) in relation to the third column (50% w/w, since commercial ZnO₂ is a 1:1 mixture of ZnO₂ and ZnO, as indicated), and their much lower surface area, the efficiency of the pellets is outstanding.

FIG. 5 shows the evolution of the overall concentrations of a mixture of volatile organosulfur compounds at the exit of the columns when air streams contaminated with a mixture of 2 ppm of 1-butanethiol (representative of group A), 2 ppm of dimethyl disulfide (group or type B), and 2 ppm of carbon disulfide (group C) were constantly introduced in four different glass columns each containing 12.0 g of the same absorbents, as in the preceding Figures.

FIG. 6 shows blank experiments with an empty column and with a column filled with SiO₂ (standard laboratory silica gel) carried out to ensure that the air pressure drop is not relevant (that is, the experimental lowering of flow rate from 3.0 L/min to 2.5 L/min in passing the air through the columns filled with pellets of zinc compounds). When the columns were filled with commercially available powdered activated carbon (3^{rd} column) or with activated carbon pellets (4^{th} column), the contaminants were partially adsorbed (that is, physically/temporarily/partially retained or adsorbed, but not chemically absorbed, see the main text).

FIG. 7 shows, on the left, the cartridge (a cartoon). Stable, white, porous pellets (top) and granules (bottom), prepared as indicated above, are shown in the middle. On the right, turbine extractor used in the container of 20 m³ contaminated with a mixture of vapors of 1-butanethiol, dimethyl disulfide, and CS₂. The turbine extractor forces the contaminated air to pass through the filter. A final EPA or HEPA filter may be included to remove any microparticles or nanoparticles (PM10/PM0.1).

### DETAILED DESCRIPTION OF THE DISCLOSURE

Unless otherwise indicated, all percentages relating to the content of a component or to a collection of components in the present disclosure refer to the weight percentage with respect to the total weight of the composition or to a weight ratio.

A filter system for the removal of some groups of volatile organosulfur compounds (so-called here VOSCs to differentiate them from the huge total number of volatile organic compounds, or VOCs, which do not contain sulfur atoms) from indoor air is disclosed, including: vapors of liquid thiols (group A); vapors of organic disulfides/trisulfides (organic oligosulfides, also called organic polysulfides or dialkyl polysulfides in general), plus oxidized derivatives, some of them present in Allium species (group B); and vapors of CS₂ and some precursors (group C).

The filter system includes a cartridge, preferably a plastic cartridge, preferably in the form of hexagonal honeycomb, cylindrical cells, square holes, or similar cells, acting as a container, where the chemical components, which chemically absorb (irreversibly react with) these vapors, are added.

These toxic and/or foul-smelling compounds are trapped by a layer of a mixture or combination of commercially available, non-toxic zinc compounds, chemically compatible and not previously reported to the best of the applicant knowledge, namely, zinc hydroxide, Zn(OH)₂, and zinc peroxide, ZnO₂. An aqueous or ethanolic suspension of the mixture, which may be viewed as an aggregate of zinc cations with hydroxide and peroxide anions as ligands, is eventually converted into porous cylinders that are easily cut into granules or pellets at will.

As explained above, the system herein disclosed is able to remove, from indoor air, several groups of volatile liquids that are organosulfur compounds or VOSCs including: (A) dozens of liquid thiols; (B) dialkyl disulfides/trisulfides/tetrasulfides, as well as S-oxides (thiosulfinates) of diallyl disulfide, of dipropyl disulfide, and of thiopropanal (the first S-oxide is a garlic natural product and the other two compounds are present in onions); and (C) the solvent CS₂ (S═C═S) and some precursors like HS—CS—SH and RO—CS—SH. It is recalled that in the Background Art these contaminants have been classified as VOSCs of types A, B, and C, respectively.

The combination of zinc compounds Zn(OH)₂ and ZnO₂ (in the form of granules or pellets) synergistically potentiate the removal of VOSCs over each compound individually. Some VOSCs (thiols, RSH, group A) are more prone to the formation of stable and insoluble zinc thiolates, Zn(SR)₂, and/or simply to give RS—Zn—OH intermediates, but subsequently these first zinc thiolates and/or intermediates can be more rapidly oxidized to organic disulfides (than their respective thiols, as observed in independent experiments performed in standard reaction flasks). These first or initial oxidation products are then further oxidized, as the organic disulfides dealt with in the following paragraph.

VOSCs of type B, such as R—S—S—R and R—S—S—S—R, are not acidic but they are very prone to be oxidized to thiosulfinates (R—SO—S—R) and afterwards to thiosulfonates (R—SO₂—S—R), etc. These are more polar than the starting compounds, so that they can interact strongly with the hydroxide anions of the pellets (in other words, with the OH⁻ ligands of Znₓ(OH)_{y}(O₂)_{z}). Thus, thiosulfinates, thiosulfonates, and related oxidized intermediates can be more easily retained by the absorbent mixture. Moreover, based on the known reactivity of thiosulfinates and thiosulfonates, these oxidized derivatives can be cleaved by the hydroxide anions of Zn(OH)₂ and/or of the above-indicated aggregates. For example, the reaction of thiosulfinates with hydroxide anions can slowly produce zinc sulfinates and zinc thiolates (which will be immediately oxidized by the peroxide anions), while the reaction of thiosulfonates with these hydroxide anions can rapidly produce zinc sulfonates and zinc thiolates; the later are oxidized to disulfides and again to thiosulfinates and, more slowly, to thiosulfonates, which again are susceptible to be rapidly cleaved.

In this connection, the inventors have determined pH values of 8.6 for the suspensions of crushed pellets of Zn(OH)₂—ZnO₂ in distilled water.

Therefore, R—SH (VOSCs of group A) and R—S—S—R (VOSCs of group B) will eventually be converted to white, innocuous zinc sulfonates. In the case of dialkyl trisulfides (R—S—S—S—R) and dialkyl tetrasulfides (R—S—S—S—S—R), ZnSO₄ can additionally be produced by oxidation (and cleavage of the S—SO₂—S bonds) of the non-terminal S atoms.

Finally, the pellets and granules made from Zn(OH)₂ and ZnO₂ also improve the removal of the toxic vapors of the solvent CS₂ (carbon disulfide, S═C═S) and consequently of its above-mentioned precursors (VOSCs of group C); these precursors first deliver H₂S, which is trapped as ZnS and afterwards oxidized. The fact is that Zn(OH)₂ contributes to the hydrolysis of S═C═S (formally to CO₂ and 2 H₂S, in practice to ZnCO₃ and 2 ZnS), while ZnO₂, as most peroxides, can give rise at first sight to COS (carbonyl sulfide, a gas of easy hydrolysis) and to innocuous molecular sulfur and to sulfur dioxide. In other words, the hydroxo ligands of the aggregates (pellets or granules) and the peroxo ligands of these aggregates appear to cooperatively decompose CS₂. As deduced from FIG. 4, the reaction of CS₂ with ZnO₂ is more rapid than with Zn(OH)₂. Since the sensors at the end of the columns filled with the pellets have never detected CO₂ or SO₂, it is assumed that these gases are trapped as ZnCO₃ and ZnSO₃, respectively; the latter, zinc sulfite, is expected to be eventually oxidized to zinc sulfate, ZnSO₄.

The synergic effect of the presence of both Zn(OH)₂ and ZnO₂, partially in the form of aggregates containing both hydroxide and peroxide anions as the ligands, is discussed below, in the Experimental Results section.

In the present disclosure, Zn(OH)₂ and ZnO₂ may be mixed 1 to 1 w/w, which seems close to the molar ratio, but in practice the 1:2 ratio is recommended if there are different types of VOSCs as indoor contaminants, bearing in mind that commercially available samples of ZnO₂ contain ZnO. Nevertheless, the 1:2 ratio may be modified up to 9:1 w/w if the main pollution in buildings and industrial surroundings may be caused by thiols or any acidic contaminants in general, or up to 1:9 w/w if the main contaminants are mainly removed by oxidation (that is, if the main contaminants do not contain acidic protons).

These two Zn reagents are commercially available, colorless, non-toxic solid products (actually, Zn²⁺ is crucial for the normal development of all cells, so zinc is deemed an essential bio-element for human health). By reaction with them, some contaminants (thiols) described herein are readily converted into white and solid zinc thiolates, non-toxic and non-volatile. This is a clear advantage of using Zn(OH)₂ instead of other bases, including other metallic hydroxides. The above-mentioned zinc thiolates are consecutively oxidized to zinc disulfides, zinc thiosulfinates, and zinc thiosulfonates, which may be cleaved to zinc sulfonates and zinc thiolates, which again may be oxidized.

Diallyl disulfide, other disulfides and trisulfides, and thiosulfinates (disulfide S-oxides) of Allium sativa are oxidized by ZnO₂ and afterwards are cleaved by Zn(OH)₂ (slowly in the case of thiosulfinates, rapidly in the case of thiosulfonates) and the thiolate fragments subsequently oxidized and cleaved, etc. In other words, these compounds are expected to react with the aggregates containing hydroxide and peroxide anions to eventually produce zinc salts. Similarly, dipropyl disulfide and other disulfides of Allium cepa are oxidized and then cleaved, whereas thiopropanal S-oxide (the lachrymatory factor of onion) is hydrolyzed to propanal and a low-valent sulfur acid and perhaps, partially, to non-volatile zinc propanesulfinate and oxidized to its propanesulfonate. Other frequent volatile by-products present in Allium species, well-known aldehydes and carboxylic acids of relatively low molecular weight, will be chemically absorbed due to, respectively, the oxidizing and basic features of the absorbent material.

Carbon disulfide (CS₂) is likely oxidized to COS (which readily follows its own hydrolysis and oxidation routes) and SO₂, this being converted into SO₃. Both sulfur oxides are obviously removed by the absorbent material. The reaction of CS₂ with OH⁻, to yield COS and HS⁻, also occurs, partially. All these reactions are well known and, therefore, not claimed here.

In several cases, the synergistic effect of the use of the unprecedented Zn(OH)₂—ZnO₂ combination is remarkable, as shown in the Figures below.

Regarding ZnO₂, it must be recalled that it is a peroxide, so that skin and eye contact as well as inhalation or ingestion must be avoided, and that it may react with combustible materials because of its oxidizing properties. Nevertheless, it is less toxic and hazardous than most metallic peroxides, as above mentioned, and more stable than most peroxosalts at pH>7. Zinc peroxide is commercially available as 50% pure compound in ZnO (ca. 1:1 w/w ZnO₂/ZnO mixture). It diminishes the oxidizing power of this peroxide but also its danger in relation to most alternative peroxides (since at room temperature the commercial samples of ZnO₂ are not dangerous at all). ZnO₂ is obviously converted into ZnO when it acts as an oxidant.

To summarize, the inventors have surprisingly found that the combination of the moderate basicity of Zn(OH)₂ (associated to the general tendency of R—SH and Zn ions to form insoluble zinc thiolates) with the oxidizing power of ZnO₂ allows one to simultaneously capture and remove different types of volatile organosulfur compounds (VOSCs), as indicated throughout this application. Moreover, the mixture is more efficient than the independent reagents per se and much more than the common reagent used in the petrochemical and coal industries, ZnO.

The air filter system is preferably made of one honeycomb-type cartridge or box. The container, with one cartridge of 2-4 cm height, comprises two air-permeable opposite non-woven-fabrics or EPA filters as a net or mess, to keep all the absorbent inside the cartridge, through which the indoor air flows. An initial non-woven fabrics or EPA net or mess is recommended, while a final EPA 12 or HEPA 13 filter is advisable.

Finally, the presence of Zn(OH)₂ in the absorbent material has an additional advantage, an indirect application. It is also useful, obviously, to capture/absorb gaseous hydrogen halides, hydrogen cyanide (HCN) and hydrogen azide (HN₃), as well as volatile carboxylic acids of pungent odor, such as formic acid, acetic acid, propionic acid (propanoic acid), etc., including hexanoic acid (also known as caproic acid, with its typical odor of goat sweat and dirty socks) and (E)-3-methyl-2-hexenoic acid (human sweat), which have also been successfully tested by the inventors. The indoor air quality (IAQ) can be improved if these acidic contaminants are also removed from the indoor air.

In connection with the short-chain aldehydes and carboxylic acids that have been detected among the many natural products isolated from the Allium species, the aldehydes are oxidized by ZnO₂ to acids and subsequently trapped by Zn(OH)₂, whereas the carboxylic acids are directly captured by Zn(OH)₂ as indicated in the preceding paragraph. Also, pyruvic acid, a co-product of the enzymatic decomposition of α-amino acid allin and analogues, to allicin [CH₂═CHCH₂—S(═O)—S—CH₂CH═CH₂] and analogues, can also be trapped.

### EXPERIMENTAL RESULTS

Identical amounts of granules or pellets of the Zn(OH)₂—ZnO₂ mixture (1:2 w/w), of Zn(OH)₂ powder, of ZnO₂ powder and of ZnO powder were put inside of independent laboratory glass columns (with a small piece of glass wool or cotton wool at the bottom and on the top).

Each contaminant was generated in a round-bottomed flask, under very dilute conditions, and was driven by an air flow (3 L/min) to the appropriate detector by means of a system of keys to alternative glass columns with the respective absorbents. The contamination of the gas flow in ppm was measured with commercial detectors (Aeroqual, Lander Technology-Dienmern, Temtop AQ Monitors) before entering the columns and after leaving these columns.

The use of granules (spherical) or pellets (cylindrical) gave identical contamination decreases. These porous granules and pellets, readily prepared as indicated above, were more efficient or slightly more efficient, depending on the cases, than the mixture of the two crystal solids without previous pelletization, weight to weight. This occurred despite the lower available reaction surface of the pellets. Thus, to the practical advantage of using pellets inside a filter instead of powders, the inventors attributed the performance of granules and pellets to the close neighborhood of hydroxide and peroxide anions in the zinc aggregates, so that the consecutive or concomitant acid-base reactions and oxidations may take place more quickly.

A comparison of the combination disclosed here, with powders of the individual components and with zinc oxide (ZnO), was carried out. The comparison with zinc oxide (ZnO) is crucial since, as repeatedly mentioned, is the most standard zinc reagent used in the petrochemical industry for decades, for the removal of the gases H₂S/CH₃SH and COS.

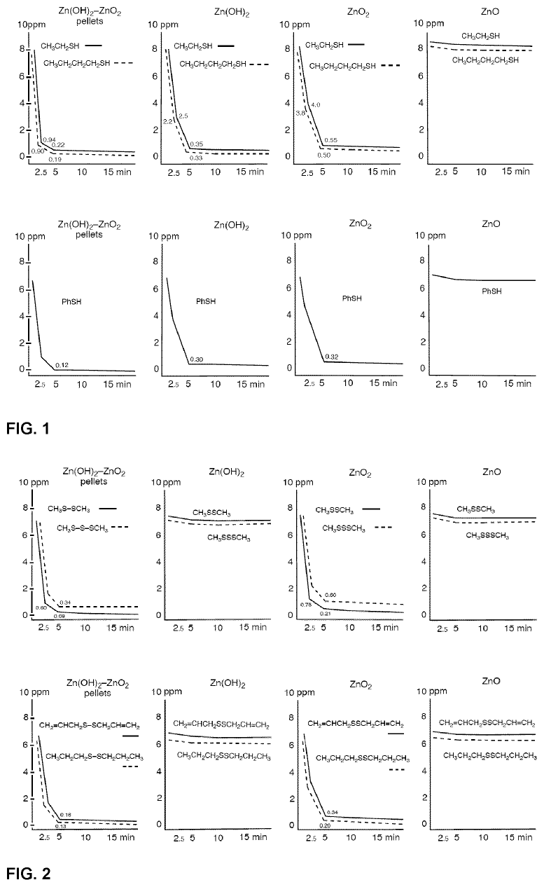

Comparative examples and results are described in FIGS. 1-6, with an air flow of 3.0 L/min that was contaminated with 6-8 ppm of samples of each class of the above-mentioned VOSCs, either chemically generated in a reaction flask or commercially available. The relative chemical absorption efficiencies were determined under extreme conditions: a continuous air stream with 6-8 ppm of each individual contaminant. The exit flow was measured to be 2.5 L/min.

FIG. 1 shows the efficiency of the pellets coming from the 1:2 w/w Zn(OH)₂—ZnO₂ mixture, in comparison with the individual reagents and with ZnO (that is, with the standard reagent for capturing H₂S in industrial settings, as above mentioned) when an air flux contaminated with 6-8 ppm of vapors of representative liquid thiols goes continuously through ca. 4-cm glass columns each filled with 12.0 g of each of the indicated absorbent materials. These thiols (called group or type A in the Background Art section) were ethanethiol and 1-butanethiol (first row) and thiophenol/benzenethiol (second row).

The granules yielded practically identical results than the pellets under the conditions reported here; they are excluded from the Figures for simplicity. Individually, both zinc compounds, Zn(OH)₂ and ZnO₂ are operative: Zn(OH)₂, because of its basicity and the formation of zinc thiolates; ZnO₂, due to its oxidizing properties. The pellets are better than the individual components, as shown in the first row of FIG. 1. The mixture of crystal powders of Zn(OH)₂ and ZnO₂, without pelletization, gave intermediate values between those shown in the 2^{nd} and 3^{rd} columns, so that they are not included. The synergistic effect is clearer when the molar ratios of the components are compared rather than the weight ratio: 1^{st} column content, 30.8 mol % of Zn(OH)₂±31.4 mol % of pure ZnO₂; 2^{nd} column, 100 mol % of Zn(OH)₂; 3^{rd} column, ca. 46 mol % of pure ZnO₂.

FIG. 2 shows how the concentrations of individual contaminants that are dimethyl disulfide (CH₃S—SCH₃) and dimethyl trisulfide (CH₃S—S—SCH₃), as examples of organic oligosulfides, (group or type B) are reduced, when, as above indicated, continuous air fluxes of the corresponding vapors go through 12.0 g of absorbent materials in glass columns (4-cm high). Again, the efficiency of the 1:2 w/w Zn(OH)₂—ZnO₂ pellets or granules is compared to those of the individual reagents and of ZnO. It is seen in the first row that Zn(OH)₂ (2^{nd} column) and ZnO (4^{th} column) do not react with CH₃S—SCH₃ and CH₃S—S—SCH₃, as expected. On a molar basis the 1^{st} column is slightly more active than the 3^{rd} column. Furthermore, it is believed that, once the S atoms are oxidized by peroxide ions, intermediate thiosulfinates and thiosulfonates [for example, CH₃S(═O)—SCH₃ and CH₃SO₂—SCH₃ in the CH₃S—SCH₃ case] may be cleaved by hydroxide ions to give innocuous zinc salts, a known rapid reaction in the case of thiosulfonates.

FIG. 2 (bottom) shows that the results with diallyl disulfide (CH₂═CHCH₂S—SCH₂CH═CH₂, from garlic) and dipropyl disulfide (CH₃CH₂CH₂S—SCH₂CH₂CH₃, from onion) are parallel to those obtained with dimethyl disulfide (CH₃S—SCH₃).

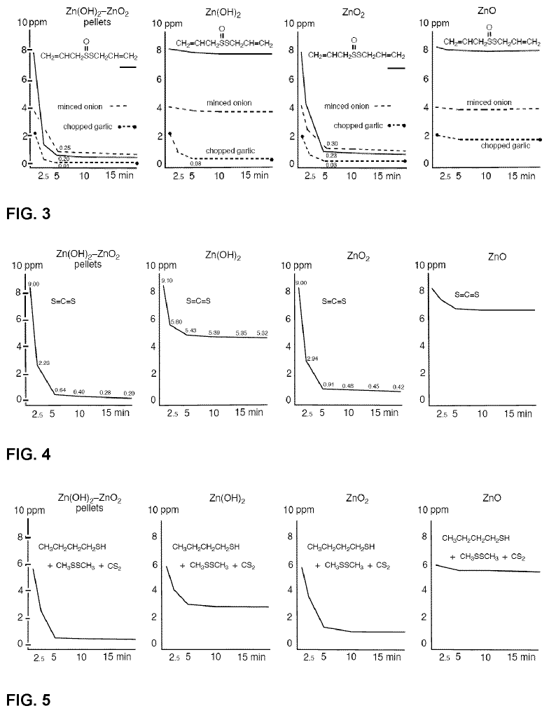

In FIG. 3, allicin (CH₂═CHCH₂—SO—S—CH₂CH═CH₂), vapors of chopped garlic (containing allicin, many VOSCs and carboxylic acids, as mentioned in the Background Art section), while vapors of freshly minced onion (containing, experimentally, the lachrymatory Z isomer of propanethial S-oxide, plus many other volatile dialkyl disulfides, thiosulfinates, aldehydes, and carboxylic acids) were similarly examined and their TVOC (total VOC) contents were compared. In this case, the initial concentration of the contaminants was lower than usual: air streams with higher concentrations of volatiles (TVOC) than 4.12 ppm (from minced onion) and 2.33 ppm (from chopped garlic) were hard to generate, even though the samples were freshly prepared from onions and garlic from the market. Under the experimental conditions, ZnO₂ is key (that is, peroxide ions are key) to significantly diminish the concentration of these vapors (including aldehydes); the presence of Zn(OH)₂ (that is, the presence of hydroxide ions), in the pellets or granules, apart from the possible advantages mentioned above, is active to trap some garlic components, mainly aliphatic acids, and 2-propene-1-thiol (“allyl mercaptan”, CH₂═CHCH₂SH).

FIG. 4 compares the chemical absorption, from a continuous air flux contaminated with vapor of carbon disulfide (the solvent CS₂), by a column of 1:2 w/w Zn(OH)₂—ZnO₂ pellets, by an identical amount of each of the individual reagents, and by an identical amount of ZnO. FIG. 4 indicates that, for the removal of CS₂, Zn(OH)₂ is not as good as ZnO₂ (its hydrolysis with moderate bases is slower than its oxidation). Even though the Zn(OH)₂—ZnO₂ pellets show only a slight synergistic effect (on a molar ratio), it has the advantage that the final oxidation coproducts, CO₂ and SO₂, are largely removed as zinc carbonate and zinc sulfate, respectively. Further experiments with a mixture of contaminants confirmed the results (FIG. 5). FIG. 5 shows how the overall concentration of contaminants evolves, when a continuous air flow simultaneously contaminated with vapors of 3 VOSCs (up to 6.1 ppm, from a nearly equimolar mixture of 3 liquids of similar boiling point) pass through a glass column filled with pellets (the 1:2 w/w Zn(OH)₂—ZnO₂ mixture), as compared to the other absorbent columns, under identical conditions. Whereas the 3 components were almost completely removed within minutes in the 1^{st} column (from 6.1±0.1 ppm to 0.5±0.1 ppm), only CH₃CH₂CH₂CH₂SH and, in part, CS₂, were expected to be trapped in the second column, in the light of preceding Figures. Practically none of the components were chemically absorbed in the last column (ZnO).

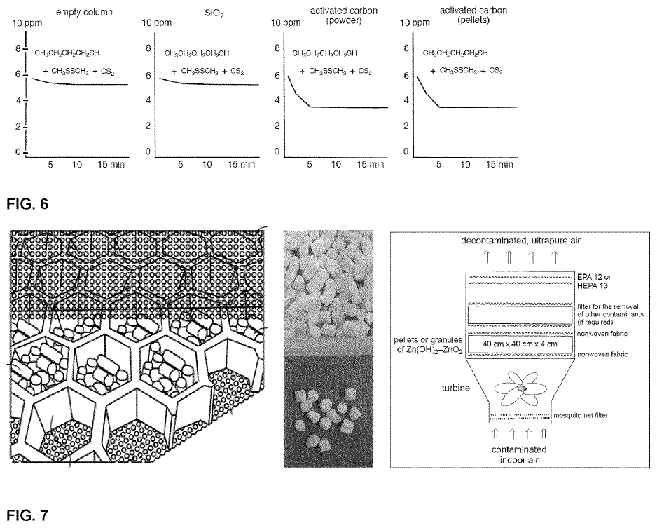

Blank experiments (FIGS. 6, 1^{st} and 2^{nd} columns) with an empty column and with a column filled with SiO₂ (standard laboratory silica gel) were also carried out to ensure that the air pressure drop (that is, the experimental lowering of flow rate from 3.0 L/min to 2.5 L/min in passing the air through the columns filled with pellets or with solid zinc compounds alone) is not relevant.

When the columns were filled with powdered activated carbon (active charcoal) or with activated carbon pellets (FIG. 6, 3^{rd} and 4^{th} columns, respectively), the contaminants were partially adsorbed (that is, physically/temporarily/partially retained, but not chemically absorbed). This assumption was confirmed by saturating these two activated-carbon columns and another filled with Zn(OH)₂—ZnO₂ pellets by passing a large excess of the 3 contaminants for 1 h. Afterwards, the entry of contaminants was cut off and pure air was passed through the system: continuous exit of 0.7-0.8 ppm of VOSCs was detected from the activated carbon columns, whereas only 0.05 ppm escaped from the column of Zn(OH)₂ —ZnO₂ pellets for a few minutes (superficially adsorbed contaminants, not having reacted yet, were desorbed, but the various zinc salts arising from the chemically absorbed contaminants obviously remained in the filter).

Additional experiments were finally performed by using a closed container of 20 m³ (a “room model”), using an air extraction turbine to which a filter of 4-cm height (40 cm length×40 cm width×4 cm height) was added upside. The filter was filled with pellets made from 1:2 w/w Zn(OH)₂—ZnO₂ mixture, as shown in FIG. 7. A continuous contaminated airstream was not introduced into the system as in the preceding laboratory experiments. The container was first contaminated, in general up to 6-8 ppm, the supply of contaminated air was then cut off, and the extractor and the corresponding detectors, already inside the container, were switched on (electrical switches outside the container). Within 15 min, the contaminant concentrations decreased to 0.2-0.5 ppm. Within ca. 60 min, they were <0.05 ppm (<50 ppb).

Therefore, the different experiments and examples disclosed herein show that the mixture of zinc compounds in the form of granules or pellets outperforms zinc oxide as well as zinc hydroxide and/or zinc peroxide applied individually, in terms of air decontamination of volatile organosulfur compounds (VOSCs) of groups or types A, B, and C.

What is claimed is:

1. A filter system for an air decontamination device for the removal of volatile organosulfur compounds (VOSCs) from indoor air at room temperature, comprising a filter cartridge, the filter cartridge comprising granules and/or pellets made of two zinc compounds, the two zinc compounds being zinc hydroxide, Zn(OH)₂, and zinc peroxide, ZnO₂, and wherein the filter acts act as an absorption filter, reacting irreversibly with the volatile organosulfur compounds of the contaminated indoor air.

2. The filter system according to claim 1, wherein the granules and/or pellets made of the two zinc compounds are prepared by the method described in the following steps:
Mixing the two zinc compounds in water or alcohol, forming a suspension;
Extruding the suspension;
Allowing the extruded suspension to dry to obtain a dried material; and
Cutting the dried material in portions.

3. The filter system according to claim 1 wherein the relative weight ratio between zinc hydroxide and zinc peroxide is between 1:9 to 9:1.

4. The filter system according to claim 3 wherein the relative weight ratio between zinc hydroxide and zinc peroxide is 1:2.

5. The filter system according to claim 1, wherein the granules have a diameter of about 3 mm and the pellets have a diameter of about 5 mm and a length of up to 5 mm.

6. The filter system according to claim 1, wherein the granules and pellets made from the two zinc compounds do not comprise any agglomerating agents or chemical binders.

7. The filter system according to claim 1, wherein the filter cartridge is placed between two filters of nonwoven fabric.

8. The filter system according to claim 1, further comprising an EPA or HEPA filter.

9. A method for removing volatile organosulfur compounds from indoor air, wherein a controlled airflow of the indoor air is passed through a filter system comprising granules and/or pellets made from zinc hydroxide, Zn(OH)₂, and zinc peroxide, ZnO₂, and wherein the volatile organosulfur compounds irreversibly react with hydroxide or peroxide anions and are thereby captured in the filter system as innocuous, white, non-volatile zinc salts.

10. The method for removing volatile organosulfur compounds from indoor air according to claim 9, wherein the volatile organosulfur compounds are vapors of liquid organosulfur compounds selected from the groups of: (A) organic thiols; (B) organic oligosulfides or dialkyl polysulfides, including disulfide derivatives present in Allium species; (C) carbon disulfide; and (D) combinations thereof.

11. The method according to claim 10, wherein the liquid organic thiols are aliphatic thiols (R—SH) and aromatic thiols (Ar—SH).

12. The method according to claim 10, wherein the volatile organosulfur compounds are aliphatic disulfides (R—S—S—R), aliphatic trisulfides (R—S—S—S—R), and related disulfides and thiosulfinates present in Allium species.

13. The method according to claim 10, wherein the volatile organosulfur compounds are vapors of carbonyl disulfide (S═C═S).

14. The method according to claim 9, wherein the controlled airflow of the indoor air is passed through the filter system at room temperature.
